(19) United States
(12) Patent Application Publication
(10) Pub. No.: US 2025/0052091 A1
(43) Pub. Date: Feb. 13, 2025

(54) Magnetic Lock System

(71) Applicant: Bradley Company, LLC, Menomonee Falls, WI (US)

(72) Inventors: Mark A. Meyer, Menomonee Falls, WI (US); David J. Yaniak, Janesville, WI (US); Zeljko Nikolic, Mequon, WI (US); John Lesniak, Brookfield, WI (US)

(21) Appl. No.: 18/717,730

(22) PCT Filed: Dec. 8, 2022
(86) PCT No.: PCT/US2022/052286

§ 371 Date: Jun. 7, 2024

Related U.S. Application Data
(60) Provisional application No. 63/287,309, filed on Dec. 8, 2021.
(60) Provisional application No. 63/426,927, filed on Nov. 21, 2022.

(51) Int. Cl. E05B 47/00; A47K 10/32; E05B 65/52; E05C 3/12

(52) U.S. Cl. CPC E05B 47/004; A47K 10/32; E05B 65/5269; A47K 2010/3246; E05B 47/0045; E05C 3/12

(57) ABSTRACT

A magnetic lock system for an enclosure includes a receiver disposed within the enclosure and a locking mechanism coupled to an interior surface of the enclosure. The locking mechanism includes a mounting plate coupled to the interior surface of the enclosure, a latch rotatable around a pivot axis and configured to engage the receiver in a locked orientation, a tension device coupled to the latch and configured to exert a force on the latch to maintain it in the locked orientation. and a magnet coupled to the latch. The magnet is configured to interact with a magnetic key to overcome the force of the tension device and transition the latch to an unlocked position. The mounting plate and the latch are pivotably connected to each other via a pin associated with the pivot axis.

### CROSS-REFERENCE TO RELATED APPLICATION

The present application claims priority to U.S. Provisional Patent Application No. 63/287,309, filed on Dec. 8, 2021, and U.S. Provisional Patent Application No. 63/426,927, filed on Nov. 21, 2022. The entire contents of which are incorporated by reference herein.

### BACKGROUND OF THE INVENTION

### 1. Field of the Invention

The present invention relates in general to the locking systems for enclosures. More particularly, the present invention relates to a magnetic lock system for enclosures including, but not limited to lavatory accessories.

### 2. Discussion of the Related Art

Many enclosures, whether lavatory accessories such as paper towel dispensers, toilet paper dispensers, etc. or other types of enclosures, are disposed in many public high-traffic areas. It is known in the art to include a lock system to secure the enclosure to prevent unauthorized third parties from opening the enclosure and removing items from within the enclosure. However, a traditional lock and key system requires multiple keys for multiple enclosures. Having to carry and sort through numerous keys when accessing and/or refilling enclosures can become burdensome on maintenance personnel.

In addition, the key opening of the lock on the front or side of the enclosure can detract from the aesthetic of the enclosure itself. Further yet, the key opening of the lock may be subject to vandalism from third parties by placing things within or defacing the key opening. Such vandalism can prevent maintenance personnel from inserting the key within the key opening of the lock and unlocking the enclosure. As a result, maintenance personnel would not be able to access the interior of the enclosure.

Thus, it would be desirable to provide a magnetic lock system for enclosures that allows maintenance personnel to access a great number of enclosures with a single magnetic key to prevent the necessity of multiple keys. Further, it would be desirable to provide a magnetic lock system for enclosures that is disposed within the enclosure such that it does not require key openings on the exterior of the enclosure.

### SUMMARY AND OBJECTS OF THE INVENTION

The present invention is directed to a magnetic lock system used with enclosures, such as but not limited to lavatory accessories.

In accordance with an embodiment of the invention, a magnetic lock system for an enclosure includes a receiver disposed within the enclosure and a locking mechanism coupled to an interior surface of the enclosure. The locking mechanism includes a mounting plate coupled to the interior surface of the enclosure, a latch rotatable around a pivot axis and configured to engage the receiver in a locked orientation, a tension device coupled to the latch and configured to exert a force on the latch to maintain it in the locked orientation, and a magnet coupled to the latch. The magnet is configured to interact with a magnetic key to overcome the force of the tension device and transition the latch to an unlocked orientation. The mounting plate and the latch are pivotably connected to each other via a pin associated with the pivot axis.

According to an aspect of the invention, the latch includes a main portion, a latching portion extending from a first end of the main portion, and a magnet portion extending from a second end of the main portion. The latching portion is configured to engage with the receiver in the locked orientation, while the magnet portion has the magnet coupled thereto.

According to another aspect of the invention, the latch may include a number of sidewalls extending downward from opposite ends of the main portion. Each sidewall includes an opening formed therein and configured to receive the pin aligned with the pivot axis. Further, the tension device is disposed around the pin.

According to yet another aspect of the invention, the latch may include a number of sidewalls extending downward from opposite ends of the magnet portion. Each sidewall includes an opening formed therein and configured to receive a pin aligned with the pivot axis. Further, the tension device is disposed around the pin.

According to another aspect of the invention, the mounting plate includes a base plate and a number of extensions extending upward from the base plate. Each extension includes an opening formed therein and configured to receive the pin aligned with the pivot axis. Additionally, the mounting plate may include a stopper element in the form of a tab that is configured to limit the pivot of the latch.

According to yet another aspect of the invention, the enclosure includes a locking plate that extends from the housing in any direction toward the locking mechanism, where the distal end of the locking tab is configured to interact with the locking mechanism. Further, the enclosure includes a housing having a number of sidewalls of any shape attached to a top wall, a bottom wall, and a back plate. The housing may further include a lock indicator that indicates where a magnetic key must be placed to transition the magnetic lock of the enclosure from the locked orientation to the unlocked orientation. In addition, the housing may further includes an indicator slot that is visually open to the inner volume of the enclosure such that a user may inspect the enclosure to determine if additional dispensing product is required.

According to another aspect of the invention, the mounting plate coupled to the interior surface of the enclosure may be configured to support a bracket mount extending from each side of a bracket, in addition to a pin secured by the bracket configured to comprise the pivot axis that the latch rotates about and a fastener that attaches each bracket mount to the mounting plate.

According to yet another aspect of the invention, the bracket mount and mounting plate may each include a textured surface that are configured to interlock with one another vertically, such that their vertical alignment may be adjusted by moving the bracket and bracket mounts so that their textured surfaces fit together differently. The textured surfaces of the bracket mount and the mounting plate may be locked together with the fastener, and additional fasteners can be used to tighten or loosen the horizontal alignment of the latch of the locking mechanism when in the locked orientation.

In addition, an aspect of the invention is a method by which the enclosure and its associated magnetic lock system may be used. The method comprises placing a counter force element such as a magnet on a lock indicator, generating an interaction between the counter force element and a magnet within a locking mechanism. That interaction between the counterforce and the magnet of the locking mechanism overcomes the force of a tension element of the locking mechanism causing a latch of the locking mechanism to rotate about a pin such that the latch is no longer disposed within an opening of a locking tab. That in turn leads to the lock system to transition from the locked orientation to the unlocked orientation.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an isometric view of an enclosure in the form of a lavatory accessories such as a paper towel dispenser for dispensing paper hand towels, according to an embodiment of the invention;

FIG. 2 is an isometric view of the paper towel dispenser of FIG. 1 in an open orientation;

FIG. 3 is an isometric view of a magnetic locking system of the enclosure in a locked position, according to an embodiment of the invention;

FIG. 4 is an isometric view of the magnetic locking system of FIG. 3 in an unlocked position;

FIG. 5 is an isometric view of a magnetic locking system of the enclosure in a locked position, according to another embodiment of the invention;

FIG. 6 is an isometric view of the magnetic locking system of FIG. 5 in an unlocked position;

FIG. 7 is an isometric view of a magnetic locking system of the enclosure in a locked position, according to yet another embodiment of the invention;

FIG. 8 is an isometric view of the magnetic locking system of FIG. 8 in an unlocked position;

FIG. 9 is an isometric view of a magnetic locking system in locked position; and

FIG. 10 is an exploded isometric view of the magnetic locking system of FIG. 9.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

Throughout this description, various terms denoting direction, such as left and right, front and rear, up and down, top and bottom, and the like may be used. The directions are not intended to be limiting but are used to describe relationships of elements with respect to each other in the accompanying drawings. Unless mutually exclusive, it is contemplated that the elements may be reversed, for example, by turning a component around or upside down without deviating from the scope of the present invention.

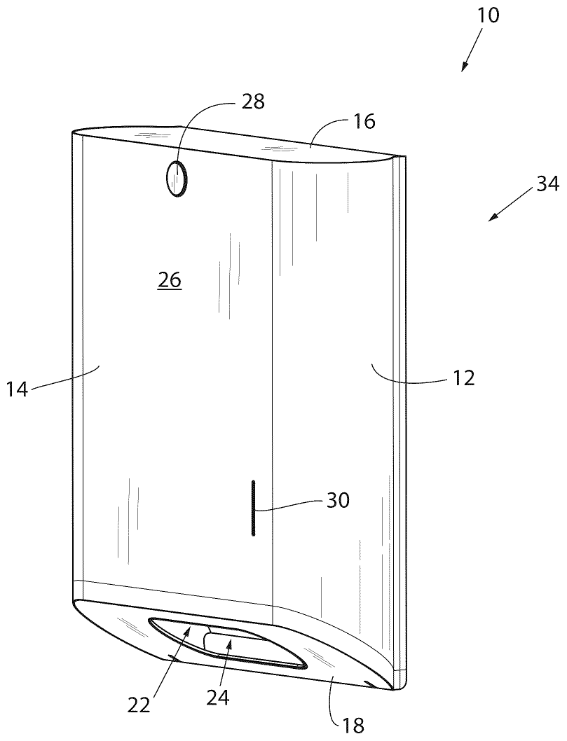

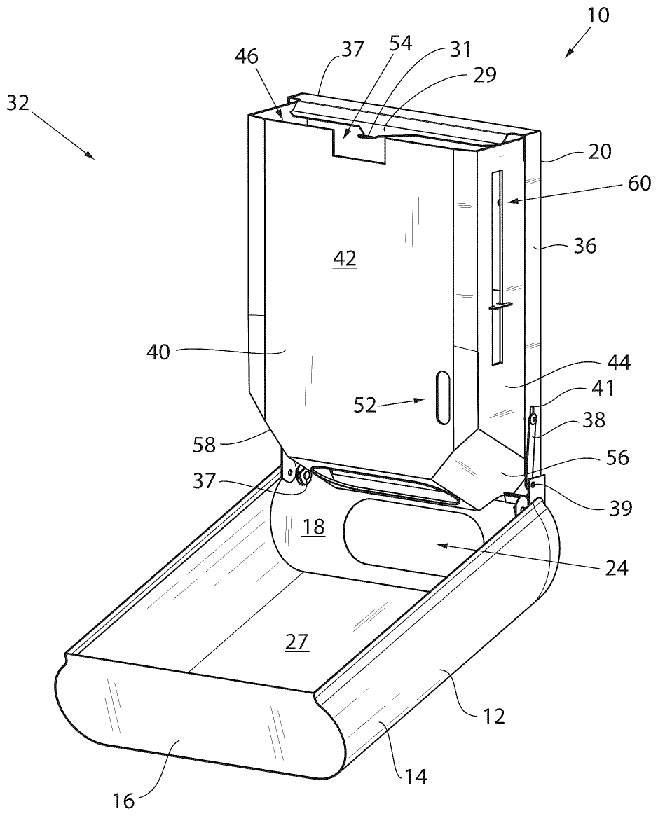

Turning initially to FIGS. 1 and 2, an enclosure 10 such as a lavatory accessory in the form of a paper towel dispenser is shown according to one embodiment of the invention. FIG. 1 illustrates the enclosure 10 in a closed orientation 34, while FIG. 2 illustrates the enclosure in an open orientation 32. The enclosure 10 may be in the form of other lavatory accessories in the form of dispenser, waste units, etc. The enclosure 10 includes a housing 12 having sidewalls 14, a top wall 16, a bottom wall 18, and a back plate 20 surrounding an inner volume 22 of the enclosure 10. In the representative embodiment of the invention, the sidewalls 14 are shown as a rounded structure. Meanwhile, in varying embodiments of the invention, the sidewalls 14 can include any number of sidewalls formed into any shape.

The bottom wall 18 may include an opening 24 formed therethrough in order to expose the inner volume 22 of the enclosure 10 to a user. In turn, a user is able to remove product, such as stacked paper towels, from the inner volume 22 of the enclosure 10 via the opening 24. Additionally, a surface of the housing 12, such as a front surface 26 of the sidewalls 14 may include a lock indicator 28 disposed adjacent the upper edge of the sidewalls 14 to indicate the location where a key may be placed to unlock the enclosure 10. This will be described in further detail below. In varying embodiments of the invention, the lock indicator 28 may be located at any location on the housing 12.

The housing 12 may also include an indicator slot 30 formed in the front surface 26 of the sidewalls 14. Preferably, the indicator slot 30 is located adjacent the bottom plate 18 of the housing. It is anticipated that the indicator slot 30 may be either completely open to the inner volume 22 of the enclosure 10 or include a clear barrier that is visually open to the inner volume 22 of the enclosure 10. In turn, a maintenance person may inspect the enclosure 10 through the indicator slot 30 to determine if product needs to be added to the enclosure 10. In other embodiments of the invention, the indicator slot 30 may be located at any location on the housing 12.

The representative embodiment of the invention further depicts a locking plate 29 disposed in an upper region of the housing 12 and displaced from the top wall 16 of the housing 12 when in the closed orientation 34. The locking plate 29 may be in the form of a cantilevered plate extending outward from an upper portion 37 of the support frame 36 and toward the front surface 26 of the housing 12. In other embodiments of the invention, the locking plate 29 may extend in any direction toward a locking mechanism 33 associated with the lock indicator 28. Further, the locking plate 29 may include a locking tab 31 extending from a distal end thereof.

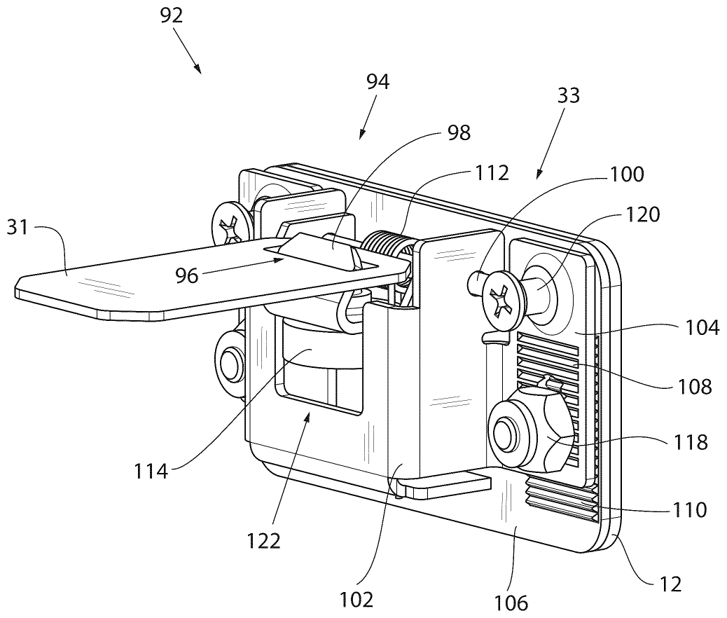

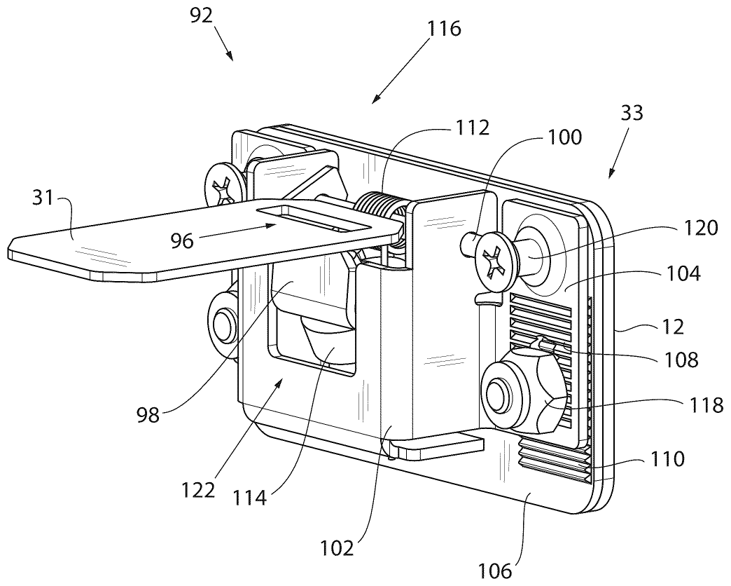

Referring now to FIGS. 3 and 4, a magnetic lock 92 and its locking mechanism 33 is shown interacting with the tab 31 of the locking plate 29, in accordance with a non-limiting embodiment of the invention. FIG. 3 illustrates the magnetic lock 92 and its locking mechanism 33 in a locked orientation 94, while FIG. 4 illustrates the magnetic lock 92 and its locking mechanism in an unlocked orientation 116.

The locking tab 31 of the locking plate 29 includes an opening 96 formed therein and configured to receive a latch 98 of the locking mechanism 33 when the locking mechanism 33 is in a locked orientation 94. The latch 98 is rotatable about a pivot axis created by a pin 100. In the representative embodiment of the invention, the pin 100 is secured to a bracket 102 attached to or commonly formed with a bracket mount 104 extending from each side of the bracket 102 in order to mount the bracket 102 and associated components to a mounting plate 106 of the locking mechanism 33. In turn, the mounting plate 106 may be coupled to are formed unitary with an inner surface 27 of the housing 12.

The locking mechanism 33 includes a tension element 112, such as, but not limited to, a coiled spring aligned with the pivot axis, that maintains the latch 98 and lock 92 in the locked orientation 94 of FIG. 3 as its neutral position. That is, without any other forces exerted on the locking mechanism 33, the latch 98 is configured to sit within a receiver in the form of the opening 96 of the locking tab 31 to prevent the housing 12 from being transitioned from the closed orientation 34 to the open position 36. It is contemplated that in embodiments where gravity is sufficient to maintain the latch 98 and lock 92 in the locked orientation 94, such embodiments may not include a tension element 112. Additional information regarding the preferred torsion spring 112 will be described in further detail below.

The locking mechanism 33 may also include a counter force element 114, such as, but not limited to, a magnet, configured to exert a force on the latch 98 in response to placement of a key element, such as, but not limited to, a magnet key. In the representative embodiment of the invention, the magnet 114 is coupled to the latch 96 at a surface adjacent the mounting plate 106 and the inner surface 27 of the housing 12. The lock indicator 28 shown in FIG. 1 identifies a location adjacent the magnet 114 of the locking mechanism 33. Additional information regarding the preferred magnet 114 will be described in further detail below.

In turn, a maintenance person may place a magnet key to the lock indicator 28 in order to interact with the magnet 114 of the locking mechanism 33 and transition the lock 92 from the locked orientation 94 of FIG. 3 to the unlocked orientation 116 of FIG. 4. Preferably, interaction between the magnetic key and the magnet 114 of the locking mechanism 33 overcomes the force of the tension element 112 and causes the latch 98 to rotate about the pin 100 so that the latch 98 is no longer disposed within the opening 96 of the locking tab 31. Once the latch 98 is no longer disposed within the opening 96 of the locking tab 31, the housing 12 may be transitioned from the closed orientation 34 to the open orientation 32.

In the representative embodiment of the invention, each bracket mount 104 may include a textured surface 108 formed thereon and configured to interfit with a textured surface 110 of the mounting plate 106. The textured surfaces 108, 110 are configured to variably interfit with each other along a vertical plane. As such, the vertical alignment of the latch 98 of the locking mechanism 33 in the locked position 94 with respect to the opening 96 of the locking tab 31 may be adjusted by moving the bracket 102 and bracket mounts 104 to have the textured surface 108 fit together with different regions of the textured surface 110. The textured surfaces 108, 110 may be sized large enough to interfit with each other or small enough to establish a friction fit between the bracket 102 and the mount 104. A fastener 118 may then be used to attach each bracket mount 104 to the mounting plate 106 and lock together the textured surfaces 108, 110.

As shown in FIGS. 3 and 4, an additional one or more fasteners 120 associated with one or more bracket mounts 104 may be tightened or loosened to adjust the horizontal alignment of the latch 98 of the locking mechanism 33 in the locked position 94 with respect to the opening 96 of the locking tab 31.

Referring again to the bracket 102 of the locking mechanism 33, FIGS. 3 and 4 illustrate the bracket 102 as a U-shaped bracket that at least partially surrounds the other components of the locking mechanism 33, such as the latch 98, magnet 114, and tension element 112. The pin 100 is run from one arm of the U-shaped bracket 102 to another arm of the U-shaped bracket 102 to provide a pivot axis and secure these components within the bracket 102. The bracket 102 further includes an opening 122 formed in a wall thereof that allows passage of the latch 98 and magnet 114 as they rotate between the locked orientation 94 of FIG. 3 and the unlocked orientation 116 of FIG. 4.

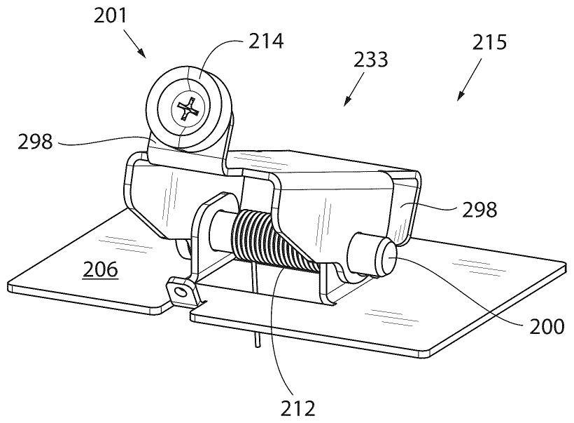

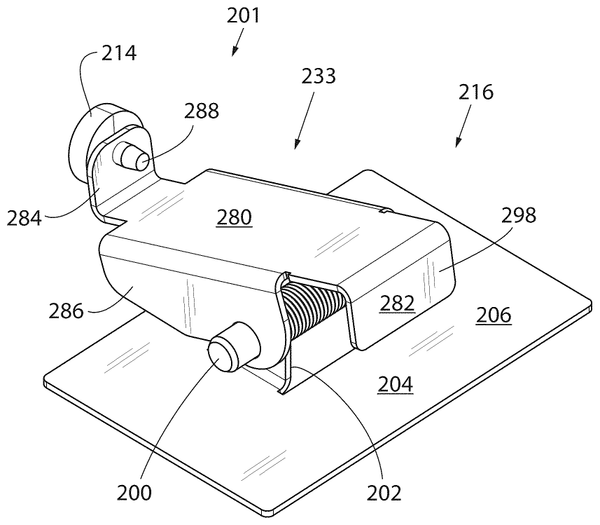

Referring next to FIGS. 5 and 6, a magnetic lock 201 and its locking mechanism 233 is shown in accordance with another non-limiting embodiment of the invention. FIG. 5 illustrates the magnetic lock 201 and its locking mechanism 233 in a locked orientation 215, while FIG. 6 illustrates the magnetic lock 201 and its locking mechanism 233 in an unlocked orientation 216.

The locking mechanism 233 includes a latch 298 similar to latch 98 of locking mechanism 33, which is configured to interfit with a receiver, such as the opening 96 of the locking tab 31 of the locking plate 29 shown in FIG. 1 when in the locked orientation 215. In varying embodiments of the invention, the latch 298 may be configured to interfit with a receiver in the form of an opening 96 in a locking tab 31 of a locking plate 29 disposed at any location within the housing 12 of the enclosure 10. In yet other embodiments of the invention, the latch 298 may be configured to interfit with a receiver defined at any location within the housing 12 of the enclosure 10.

The latch 298 is rotatable about a pivot axis created by a pin 200. As shown, the pin 200 couples the latch 298 to a mounting plate 206 of the locking mechanism 233. The mounting plate 206 may be coupled to are formed unitary with an inner surface 27 of the housing 12. In some embodiments of the invention, the interior surface 27 may be the associated with the any of the sidewalls and/or door of the enclosure 10.

In the representative embodiment of the invention, the mounting plate 206 includes a base plate 204 and a number of extensions 202 extending upward from the base plate 204. Preferably, the extensions 202 extend perpendicular to the base plate 204. Each extension 202 may include an opening formed therein and configured to receive the above discussed pin 200, which acts as the pivot axis.

In the representative embodiment of the invention, the latch 298 includes a plurality of surfaces including a main portion 280, a latching portion 282, a magnet portion 284, and a number of sidewalls 286. As shown in FIGS. 5 and 6, the latching portion 282 is disposed at a first end of the main portion 280 and extends at an angle therefrom, preferably perpendicular. Meanwhile, the magnet portion 284 is disposed at a second end of the main portion 280 and extends at an angle therefrom, also preferably perpendicular. While FIGS. 5 and 6 depict the latching portion 282 and the magnet portion 284 extending in opposite directions from the main portion 280, it is contemplated that the latching portion 282 and the magnet portion 283 may extend from the main portion 280 in the same or similar directions.

The one or more sidewalls 286 may extend from opposite sides of the main portion 280 in a direction downward and preferably perpendicular to the main portion 280 of the latch 298. Similar to the extensions 202, each sidewall 286 may include an opening formed therein and configured to receive the above discussed pin 200, which acts as the pivot axis. That is, the openings of the extension 202 and the sidewalls 286 may be aligned so that the pin 200 extends therethrough and pivotably couples the latch 298 to the mounting plate 206.

The locking mechanism 233 includes a tension element 212, such as, but not limited to, a coiled spring aligned with the pivot axis and oriented around the pin 200. The ends of the tension element 212 are further coupled to the latch 298 and the mounting plate 206, respectively. The tension element 212 is configured to maintain the latch 298 and the lock 201 in the locked orientation 215 of FIG. 5 as its neutral position. That is, without any other forces exerted on the locking mechanism 233, the latch 298, and more specifically the latching portion 282 of the latch 298, is configured to sit within a receiver defined within the housing 12 of the enclosure 10 to prevent the housing 12 from being transitioned from the closed position 34 to the open position 36. It is contemplated that in embodiments where gravity is sufficient to maintain the latch 298 and lock 201 in the locked orientation 215, such embodiments may not include a tension element 212. Additional information regarding the preferred torsion spring 212 will be described in further detail below.

The locking mechanism 233 may also include a counter force element 214, such as, but not limited to, a magnet, configured to exert a force on the latch 298 in response to placement of a key element, such as, but not limited to, a magnet key. As shown in FIGS. 5 and 6, the magnet 214 may be coupled to the magnet portion 284 of the latch 298 via a fastener 288. In varying embodiments of the invention, the magnet 214 may be coupled to the magnet portion 284 of the latch 298 through various methods of attachment. Additionally, when the lock 201 is secured within the enclosure 10, the magnet 214 is placed adjacent an inner surface of the housing 12 so that it may interact with a magnet key. The lock indicator 28 shown in FIG. 1 identifies a location adjacent the magnet 214 of the locking mechanism 33. Additional information regarding the preferred magnet 214 will be described in further detail below.

In turn, a maintenance person may place a magnet key to the lock indicator 28 in order to interact with the magnet 214 of the locking mechanism 233 and transition the lock 201 from the locked orientation 215 of FIG. 5 to the unlocked orientation 216 of FIG. 6. Preferably, interaction between the magnet key and the magnet 214 of the locking mechanism 233 overcomes the force of the tension element 212 and causes the latch 298 to rotate about the pin 200 so that the latching portion 282 of the latch 298 is no longer disposed within a receiver defined within the housing 12 of the enclosure 10. Once the latch 298 has transitioned to the unlocked orientation 216, the housing 12 may be transitioned from the closed position 34 to the open position 32.

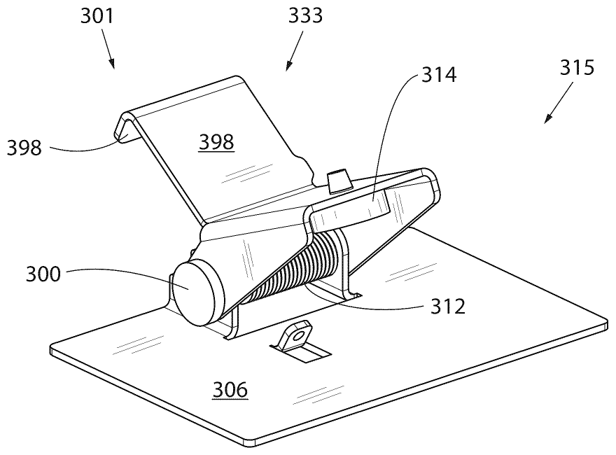

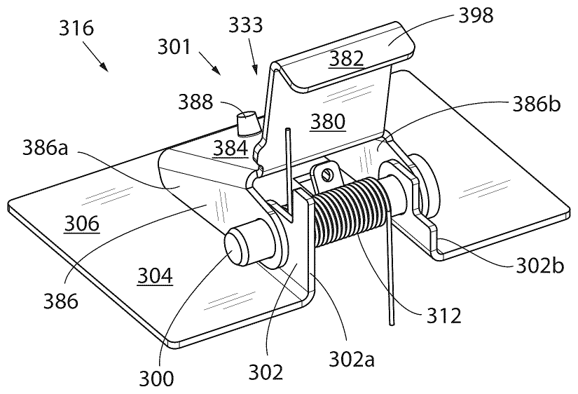

Next, FIGS. 7 and 8 depict another non-limiting embodiment of a magnetic lock 301 and its locking mechanism 333 capable of interacting with the tab 31 of the locking plate 29. FIG. 7 illustrates the magnetic lock 301 and its locking mechanism 333 in a locked orientation 315, while FIG. 8 illustrates the magnetic lock 301 and its locking mechanism 333 in an unlocked orientation 316.

Similar to locking mechanism 233, locking mechanism 333 includes a latch 398 that is configured to interfit with a receiver when in the locked orientation, such as the opening 96 of the locking tab 31 of the locking plate shown in FIG. 1. In varying embodiments of the invention, the latch 398 may be configured to interfit with a receiver in the form of an opening 96 in a locking tab 31 of a locking plate 29 disposed at any location within the housing 12 of the enclosure 10. In yet other embodiments of the invention, the latch 398 may be configured to interfit with a receiver defined at any location within the housing 12 of the enclosure 10.

The latch 398 is rotatable about a pivot axis created by a pin 300. As shown, the pin 300 couples the latch 398 to a mounting plate 306 of the locking mechanism 333. The mounting plate 306 may be coupled to are formed unitary with an inner surface 27 of the housing 12. In some embodiments of the invention, the interior surface 27 may be the associated with the any of the sidewalls and/or door of the enclosure 10.

In the representative embodiment of the invention, the mounting plate 306 includes a base plate 304 and a number of extensions 302 extending upward from the base plate 304. Preferably, the extensions 302 extend perpendicular to the base plate 304. Each extension 302 may include an opening formed therein and configured to receive the above discussed pin 300, which acts as the pivot axis. While FIGS. 7 and 8 depict first and second extensions 302a, 302b, varying embodiments of the invention may use any number of extensions 302.

Meanwhile, the representative embodiment of the latch 398 includes a plurality of surfaces including a main portion 380, a latching portion 382, a magnet portion 384, and a number of sidewalls 386. As shown in FIGS. 7 and 8, the latching portion 382 is disposed at a first end of the main portion 382 and extends at an angle therefrom, preferably forming a perpendicular angle. Meanwhile, the magnet portion 384 is disposed at a second end of the main portion 380 and extends at an angle therefrom. The sidewalls 386 may extend from opposite sides of the magnet portion 384 in a direction downward and preferably perpendicular to the magnet portion 384 of the latch 398.

Similar to the extensions 302, each sidewall 386 may include an opening formed therein and configured to receive the above discussed pin 300, which acts as the pivot axis. That is, the openings of the extension 302 and the sidewalls 386 may be aligned so that the pin 300 extends therethrough and pivotably couples the latch 398 to the mounting plate 306. While FIGS. 7 and 8 depict first and second sidewalls 386a, 386b, varying embodiments of the invention may use any number of sidewalls 386.

The locking mechanism 333 includes a tension element 312, such as, but not limited to, a coiled spring aligned with the pivot axis and oriented around the pin 300. The ends of the tension element 312 are further coupled to the latch 398 and the mounting plate 306, respectively. The tension element 312 is configured to maintain the latch 398 and the lock 301 in the locked orientation 315 of FIG. 7 as its neutral position. As a result, without any other forces exerted on the locking mechanism 333, the latch 398, and more specifically the latching portion 382 of the latch 398, is configured to sit within a receiver defined within the housing 12 of the enclosure 10 to prevent the housing 12 from being transitioned from the closed position 34 to the open position 36. It is contemplated that in embodiments where gravity is sufficient to maintain the latch 398 and lock 301 in the locked orientation 315, such embodiments may not include a tension element 312. Additional information regarding the preferred torsion spring 312 will be described in further detail below.

The locking mechanism 333 may also include a counter force element 314, such as, but not limited to, a magnet, configured to exert a force on the latch 398 in response to placement of a key element, such as, but not limited to, a magnet key. As shown in FIGS. 7 and 8, the magnet 314 may be coupled to the magnet portion 384 of the latch 398 via a fastener 388. In varying embodiments of the invention, the magnet 314 may be coupled to the magnet portion 384 of the latch 398 through various methods of attachment. Additionally, when the lock 301 is secured within the enclosure 10, the magnet 314 is placed adjacent an inner surface of the housing 12 so that it may interact with a magnet key. The lock indicator 28 shown in FIG. 1 identifies a location adjacent the magnet 314 of the locking mechanism 33. Additional information regarding the preferred magnet 314 will be described in further detail below.

In turn, a maintenance person may place a magnet key to the lock indicator 28 in order to interact with the magnet 314 of the locking mechanism 333 and transition the lock 301 from the locked orientation 315 of FIG. 7 to the unlocked orientation 316 of FIG. 8. Preferably, interaction between the magnet key and the magnet 314 of the locking mechanism 333 overcomes the force of the tension element 312 and causes the latch 398 to rotate about the pin 300 so that the latching portion 382 of the latch 398 is no longer disposed within a receiver defined within the housing 12 of the enclosure 10. Once the latch 398 has transitioned to the unlocked orientation 316, the housing 12 may be transitioned from the closed position 34 to the open position 32.

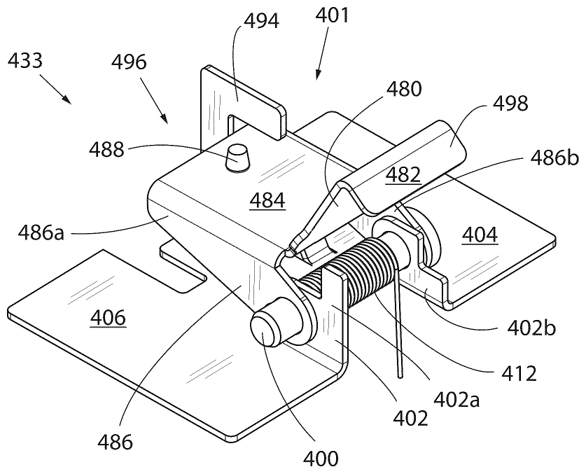

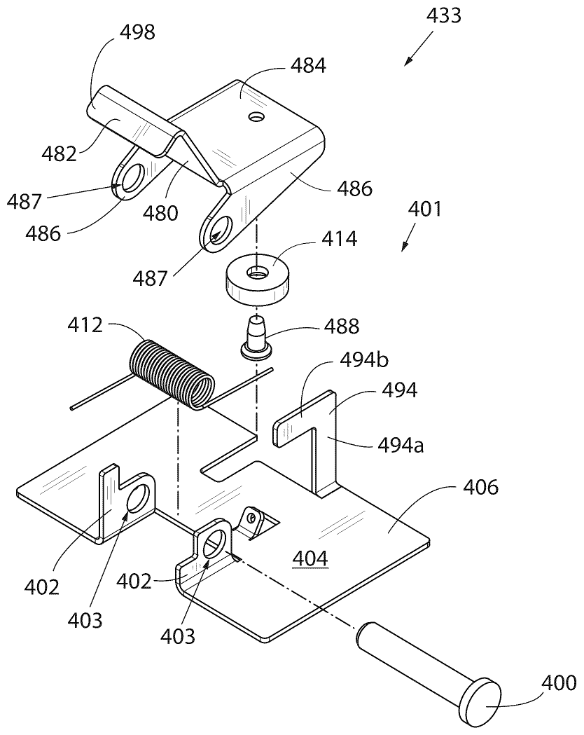

Next, FIGS. 9 and 10 depict another non-limiting embodiment of a magnetic lock 401 and its locking mechanism 433 capable of interacting with the tab 31 of the locking plate 29. FIGS. 9 and 10 both illustrates the magnetic lock 401 and its locking mechanism 433 in a locked orientation 415, while an unlocked orientation (not shown) of the magnetic lock 401 and its locking mechanism 433 is similar to that shown in FIG. 8 regarding the unlocked orientation 316 of the magnetic lock 301 and its locking mechanism 333.

Similar to locking mechanism 333, locking mechanism 433 includes a latch 498 that is configured to interfit with a receiver when in the locked orientation 415, such as the opening 96 of the locking tab 31 of the locking plate 29 shown in FIG. 1. In varying embodiments of the invention, the latch 498 may be configured to interfit with a receiver in the form of an opening 96 in a locking tab 31 of a locking plate 29 disposed at any location within the housing 12 of the enclosure 10. In yet other embodiments of the invention, the latch 498 may be configured to interfit with a receiver defined at any location within the housing 12 of the enclosure 10.

The latch 498 is rotatable about a pivot axis created by a pin 400. As shown, the pin 400 couples the latch 498 to a mounting plate 406 of the locking mechanism 433. The mounting plate 406 may be coupled to are formed unitary with an inner surface 27 of the housing 12. In some embodiments of the invention, the interior surface 27 may be the associated with the any of the sidewalls and/or door of the enclosure 10.

In the representative embodiment of the invention, the mounting plate 406 includes a base plate 404 and a number of extensions 402 extending upward from the base plate 404. Preferably, the extensions 402 extend perpendicular to the base plate 404. Each extension 402 may include an opening 403 formed therein and configured to receive the above discussed pin 400, which acts as the pivot axis. While FIGS. 9 and 10 depict first and second extensions 402a, 402b, varying embodiments of the invention may use any number of extensions 402.

In addition, the mounting plate 406 includes a stopper element 494 in the form of a tab that extends upward from the base plate 404. Preferably, the tab 494 extends perpendicularly upward from the base plate 404. The tab 494 includes a first upward segment 494a and a second lateral segment 494b. The first upward segment 494a extends upward from the base plate 404 at or adjacent a rear edge of the base plate 404, from a first lower end to a second upper end. In turn, the second lateral segment 494b extends laterally inward from the second upper end of the first upward segment 494a. As shown in FIG. 10, the upward and lateral segments 494a, 494b of the tab 494 form an L-shape. The function of the tab 494 will be described in further detail below.

The representative embodiment of the latch 498 includes a plurality of surfaces including a main portion 480, a latching portion 482, a magnet portion 484, and a number of sidewalls 486. As shown in FIGS. 9 and 10, the latching portion 482 is disposed at a first end of the main portion 482 and extends at an angle therefrom, preferably forming a perpendicular angle. Meanwhile, the magnet portion 484 is disposed at a second end of the main portion 480 and extends at an angle therefrom. The sidewalls 486 may extend from opposite sides of the magnet portion 484 in a direction downward and preferably perpendicular to the magnet portion 484 of the latch 498.

Similar to the extensions 402, each sidewall 486 may include an opening 487 formed therein and configured to receive the above discussed pin 400, which acts as the pivot axis. That is, the openings of the extension 402 and the sidewalls 486 may be aligned so that the pin 400 extends therethrough and pivotably couples the latch 498 to the mounting plate 406. While FIGS. 9 and 10 depict first and second sidewalls 486a, 486b, varying embodiments of the invention may use any number of sidewalls 486.

The locking mechanism 433 includes a tension element 412, such as, but not limited to, a coiled spring aligned with the pivot axis and oriented around the pin 400. The ends of the tension element 412 are further coupled to the latch 498 and the mounting plate 406, respectively. The tension element 412 is configured to maintain the latch 498 and the lock 401 in the locked orientation 415 of FIG. 8 as its neutral position. As a result, without any other forces exerted on the locking mechanism 433, the latch 498, and more specifically the latching portion 482 of the latch 498, is configured to sit within a receiver defined within the housing 12 of the enclosure 10 to prevent the housing 12 from being transitioned from the closed position 34 to the open position 36. It is contemplated that in embodiments where gravity is sufficient to maintain the latch 498 and lock 401 in the locked orientation 415, such embodiments may not include a tension element 412. Additional information regarding the preferred torsion spring 412 will be described in further detail below.

The locking mechanism 433 may also include a counter force element 414, such as, but not limited to, a magnet, configured to exert a force on the latch 498 in response to placement of a key element, such as, but not limited to, a magnet key. As shown in FIGS. 9 and 10, the magnet 414 may be coupled to the magnet portion 484 of the latch 498 via a fastener 488. In varying embodiments of the invention, the magnet 414 may be coupled to the magnet portion 484 of the latch 498 through various methods of attachment. Additionally, when the lock 401 is secured within the enclosure 10, the magnet 414 is placed adjacent an inner surface of the housing 12 so that it may interact with a magnet key. The lock indicator 28 shown in FIG. 1 identifies a location adjacent the magnet 414 of the locking mechanism 33. Additional information regarding the preferred magnet 414 will be described in further detail below.

In turn, a maintenance person may place a magnet key to the lock indicator 28 in order to interact with the magnet 414 of the locking mechanism 433 and transition the lock 401 from the locked orientation 415 of FIG. 9 to an unlocked orientation. Preferably, interaction between the magnet key and the magnet 414 of the locking mechanism 433 overcomes the force of the tension element 412 and causes the latch 498 to rotate about the pin 400 so that the latching portion 482 of the latch 498 is no longer disposed within a receiver defined within the housing 12 of the enclosure 10. Once the latch 498 has transitioned to the unlocked orientation, the housing 12 may be transitioned from the closed position 34 to the open position 32.

Referring again to tab 494, tab 494 limits the pivoting of the latch about the pivot axis to the neutral position associated with the lock orientation 415 of the magnetic lock 401 and its locking mechanism 433. As shown in FIG. 9, the latch 498 comes into contact with the tab 494 when in the locked orientation 415. In the representative embodiment of the invention, a side of the magnet portion 484 opposite the magnet 414 is in contact with the lateral segment 494b of the tab 494 when the locking mechanism 433 of the lock 401 is in the locked orientation. The tab 494 is configured to have the latch 498 disposed at a location that allows the magnetic key to be removed and the enclosure still be closed by merely pushing the cover closed to engage the latch 498 with the receiver.

In addition to the structural embodiments of this invention, this invention describes the method by which the various embodiments of the enclosure 10 and its associated magnetic lock 92, 201, 301 system may be utilized. The method comprises placing a key element, such as a magnet key, on a lock indicator 28, generating an interaction between the key element and the counter force element 114, 214, or 314, such as a magnet, within the magnetic lock 92, 201, 301 which overcomes the force of a tension element 112, 212, 312 of the locking mechanism. This causes the latch 98, 298, 398 of the magnetic lock 92, 201, 301 to rotate about a pin 100, 200, 300 such that the latch 98, 298, 398 is no longer disposed within an opening 96 of a locking tab 31; which leads to the magnetic lock 92, 201, 301 to transition from a locked orientation 94, 215, 315 to an unlocked orientation 116, 216, 316.

As mentioned above, contemplated preferred embodiments of the magnet 114, 214, 314 and contemplated preferred embodiments of the torsion spring 112, 212, 312 will now be described. In preferred embodiments of the invention, the magnet 114, 214, 314 may be a neodymium magnet. More preferably, the magnet 114, 214, 314 may be an N temperature type neodymium magnet. Even more preferably, the magnet 114, 214, 314 may have a maximum energy product of 35-50 MGOe. Further preferably, the magnet 114, 214, 314 may be an N42 type neodymium magnet (an N temperature type and a maximum energy product of 42 MGOe).

Additionally, the magnet 114, 214, 314 may be sized with a preferred width-to-height ratio. Preferably, the width-to-height ratio is less than 5 to increase the maximum working temperature of the magnet 114, 214, 314 without losing its magnetization. More preferably, the width-to-height ratio is less than 4. Even more preferably, the width-to-height ratio is 3.33. Further, a preferable width of the magnet 114, 214, 314 may be 10 mm and a preferable height of the magnet 114, 214, 314 may be 3 mm, which results in a width-to-height ration of 3.33.

Preferably, the torsion spring 112, 212, 312 has a mandrel size of 1-10 mm. More preferably, the mandrel size of the torsion spring 112, 212, 312 is 3.5-7.5 mm. Even more preferably, the mandrel size of the torsion spring 112, 212, 312 is 5.5 mm. In addition, each leg of the torsion spring 112, 212, 312 may be a straight leg orientation and have a length of 10-30 mm. More preferably, each leg of the torsion spring 112, 212, 312 may have a leg length of 15-25 mm. Even more preferably, the leg length of the torsion spring 112, 212, 312 is 19 mm. Preferably, the torsion spring 112, 212, 312 may include 15-25 coils. More preferably, the torsion spring 112, 212, 312 includes 22 coils.

Although the best mode contemplated by the inventors of carrying out the present invention is disclosed above, practice of the present invention is not limited thereto. It will be manifest that the various additions, modifications, and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A magnetic lock system for an enclosure, the magnetic lock system comprising:
a receiver disposed within the enclosure;
a locking mechanism coupled to an interior surface of the enclosure, the lock mechanism including:
a latch rotatable around a pivot axis and configured to engage the receiver in a locked orientation;
a tension device coupled to the latch and configured to exert a force on the latch to maintain it in the locked orientation; and
a magnet coupled to the latch, the magnet configured to interact with a magnetic key to overcome the force of the tension device and transition the latch to an unlocked position.

2. The magnetic lock system of claim 1, wherein the latch comprises:
a main portion;
a latching portion extending from a first end of the main portion, the latching portion configured to engage with the receiver in the locked orientation; and
a magnet portion extending from a second end of the main portion, the magnet portion having the magnet coupled thereto.

3. The magnetic lock system of claim 2, wherein the latch further comprises a plurality of sidewalls extending downward from opposite ends of the main portion;
wherein each sidewall includes an opening formed therein and configured to receive a pin aligned with the pivot axis; and
wherein the tension device is disposed around the pin.

4. The magnetic lock system of claim 2, wherein the latch further comprises a plurality of sidewalls extending downward from opposite ends of the magnet portion;
wherein each sidewall includes an opening formed therein and configured to receive a pin aligned with the pivot axis; and
wherein the tension device is disposed around the pin.

5. The magnetic lock system of claim 1 further comprising a mounting plate coupled to the interior surface of the enclosure;
wherein the mounting plate and the latch are pivotably coupled to each other via a pin associated with the pivot axis.

6. The magnetic lock system of claim 5, wherein the mounting plate includes a base plate and a plurality of extensions extending upward from the base plate;
wherein each extension includes an opening formed therein, the opening configured to receive a pin aligned with the pivot axis; and
wherein the tension device is disposed around the pin.

7. The magnetic lock system of claim 5, wherein the mounting plate further includes a stopper element configured to limit the pivot of the latch.

8. The magnetic lock system of claim 1, wherein the enclosure further comprises a housing, the housing including:
a number of sidewalls formed in any shape;
a top wall attached to the sidewalls;
a bottom wall attached to the side walls; and
a back plate attached to the bottom wall, top wall, and sidewalls;
wherein the housing surrounds an inner volume of the enclosure.

9. The magnetic lock system of claim 8, wherein the housing of the enclosure further comprises:
a lock indicator that indicates the location where a magnetic key must be placed by a user to transition the magnetic lock of the enclosure from the locked orientation to the unlocked orientation; and
an indicator slot that may be either completely open to the inner volume of the enclosure or that includes a clear barrier that is visually open to the inner volume of the enclosure such that a user may inspect the enclosure to determine if additional dispensing product is needed.

10. The magnetic lock system of claim 9, wherein the receiver is in the form of a locking plate that extends from the housing in any direction toward the locking mechanism associated with the lock indicator; and
wherein the distal end of the locking plate may include a locking tab configured to interact with the locking mechanism.

11. The magnetic lock system of claim 1, wherein the enclosure further comprises:
a mounting plate coupled to the interior surface of the enclosure;
a bracket mount, extending from each side of a bracket and associated components, configured to mount the bracket and its associated components to the mounting plate;
the bracket;
a pin secured to the bracket, the pin being configured to comprise the pivot axis about which the latch may rotate; and
a fastener attaching each bracket mount to the mounting plate

12. The magnetic lock system of claim 11, wherein the bracket mount and mounting plate each include a textured surface formed thereon configured to fit with the each other along a vertical plane such that the vertical alignment of the latch of the locking mechanism when configured in the locked orientation may be adjusted by moving the bracket and bracket mounts such that the textured surface of the bracket mount fits together with a different vertically aligned region of the textured surface of the mounting plate;
wherein the fastener locks together the textured surfaces of the bracket mount and mounting plate; and
wherein an additional one or more fasteners associated with one or more bracket mounts may be tightened or loosened to adjust the horizontal alignment of the latch of the locking mechanism in the locked orientation

13. The magnetic lock system of claim 1, wherein the enclosure further comprises:
a pin that couples the latch to a mounting plate and acts as the pivot axis for the latch; and
a mounting plate coupled to the interior surface of the enclosure, the mounting plate including:
a base plate; and
a number of extensions extending upward from the base plate, wherein each extension may include an opening formed therein configured to receive the pin.

14. A method of operating a magnetic lock system for an enclosure, the method comprising:
providing a housing, a lock indicator, a magnet key element, a magnet within the locking mechanism, a tension element within the locking mechanism, a latch within the locking mechanism, a pin within the locking mechanism, and a locking tab within the locking mechanism that contains an opening fitted to be able to contain the latch in order to maintain the magnetic lock system in a locked orientation;
placing the magnet key element on the lock indicator;
generating an interaction between the magnet key element and the magnet of the locking mechanism, the interaction between the magnet key element and the magnet of the locking mechanism configured to overcome a force of the tension element of the locking mechanism;
causing the latch of the locking mechanism to rotate about the pin of the locking mechanism such that the latch is no longer disposed within the opening of the locking tab; and
in response to the latch no longer being within the opening of the locking tab, transitioning the magnetic lock system from the locked orientation to an unlocked orientation.

15. An enclosure comprising:
a housing surrounding an inner volume of the enclosure, the housing including:
a number of sidewalls;
a top wall attached to the sidewalls;
a bottom wall attached to the sidewalls;
a back plate attached to the bottom wall, top wall, and sidewalls; and
a door pivotably attached to the at least one of the bottom wall, top wall, and sidewalls;
a lock indicator disposed on the door of the housing;
a magnetic lock system including:
a receiver disposed within the housing;
a locking mechanism coupled to an interior surface of the enclosure, the locking mechanism including:
a latch rotatable around a pivot axis and configured to engage the receiver in a locked orientation;
a tension device coupled to the latch and configured to exert a force on the latch to maintain it in the locked orientation; and
a magnet coupled to the latch, the magnet configured to interact with a magnetic key to overcome the force of the tension device and transition the latch to an unlocked position when the magnetic key is aligned with the lock indicator.

16. The enclosure of claim 15, wherein the latch comprises:
a main portion;
a latching portion extending from a first end of the main portion, the latching portion configured to engage with the receiver in the locked orientation; and
a magnet portion extending from a second end of the main portion, the magnet portion having the magnet coupled thereto.

17. The enclosure of claim 16, wherein the latch further comprises a plurality of sidewalls extending downward from opposite ends of the main portion;
wherein each sidewall includes an opening formed therein and configured to receive a pin aligned with the pivot axis; and
wherein the tension device is disposed around the pin.

18. The enclosure of claim 16, wherein the latch further comprises a plurality of sidewalls extending downward from opposite ends of the magnet portion;
wherein each sidewall includes an opening formed therein and configured to receive a pin aligned with the pivot axis; and
wherein the tension device is disposed around the pin.

19. The enclosure of claim 15, further comprising a mounting plate coupled to the interior surface of the enclosure;
wherein the mounting plate and the latch are pivotably coupled to each other via a pin associated with the pivot axis.

20. The magnetic lock system of claim 19, wherein the mounting plate includes a base plate and a plurality of extensions extending upward from the base plate, each extension including an opening formed therein and configured to receive a pin aligned with the pivot axis; and
a tab extending upward from the base plate and configured to limit the pivot of the latch.
